(19) United States
(12) Patent Application Publication
(10) Pub. No.: US 2012/0233651 A1
(43) Pub. Date: Sep. 13, 2012

(54) IPTV RECEIVER AND METHOD FOR PROVIDING CONTENT

(76) Inventors: Hyeon Jae Lee, Seocho-gu (KR); Kyung Ho Kim, Seocho-gu (KR)

(21) Appl. No.: 13/500,533

(22) PCT Filed: Oct. 7, 2010
(86) PCT No.: PCT/KR10/06845

§ 371 Date: Apr. 5, 2012

Related U.S. Application Data
(60) Provisional application No. 61/249,259, filed on Oct. 7, 2009.

(51) Int. Cl. H04N 21/6371

(52) U.S. Cl. 725/110

(57) ABSTRACT

Disclosed are an IPTV receiver and a method for providing content for same. The IPTV receiver according to one embodiment of the present invention includes a network interface for transmitting and receiving IP packets, a Universal Plug and Play (UPnP) manager for connecting to a home network via the network interface, and a service delivery manager for controlling transmission and reception of data, wherein the UPnP manager connects to a mobile terminal through the home network and receives a content Identifier (ID) from the mobile terminal through the home network by controlling the network interface, and the service delivery manager receives content using the content ID by controlling the network interface, and wherein the content ID includes address information about a content provider from which the content can be received. In addition, a method for providing content at an Internet Protocol Television (IPTV) receiver, the method includes connecting to a mobile terminal through a home network, receiving a content Identifier (ID) from the mobile terminal through the home network, and receiving content using the content ID, wherein the content ID includes address information about a content provider from which the content can be received.

This application claims the benefit of U.S. Provisional Application No. 61/249,259, filed on Oct. 7, 2009, in the name of inventors LEE, Hyeon Jae and KIM, Kyung Ho titled “Three screen application using IPTV and second display device”, which is hereby incorporated by reference.

### BACKGROUND OF THE INVENTION

1. Field of the Invention

The present invention relates to an Internet Protocol Television (IPTV) and a content providing method thereof, and more particularly, to a digital broadcasting receiver for providing content using a mobile terminal in a broadcasting environment interacting with a home network and a content providing method thereof.

2. Discussion of the Related Art

Conventionally, a TV transmits content created by a broadcasting station via a wave propagation medium such as terrestrial, cable, or satellite broadcasting and a viewer views a broadcast program in a TV receiver capable of receiving a wave propagation medium. However, owing to the evolution from conventional analog broadcasting to digital broadcasting and commercialization of digital broadcasting, various types of content including real-time broadcasting, Content on Demand (CoD), games, news, etc. can be provided to viewers through the Internet connected to each home as well as the conventional propagation media. For example, IPTV provides content through the Internet. IPTV refers to a service of providing information service, video content, and broadcasting on TVs through a very high-speed Internet.

IPTV is similar to conventional cable broadcasting or satellite broadcasting except for its interaction capability. Compared to conventional public broadcasting, cable broadcasting, or satellite broadcasting, IPTV allows a viewer to view an intended program at any time. An IPTV receiver can provide detailed information about content, access positions of the content, service provider information, service channels, etc. in relation to various services by means of a content guide service. Along with the development of home network technology, services can be provided through interaction between digital broadcasting receivers such as IPTV receivers and various mobile terminals

### SUMMARY OF THE INVENTION

Accordingly, the present invention is directed to a [title] that substantially obviates one or more problems due to limitations and disadvantages of the related art.

An object of the present invention devised to solve the conventional problem is to provide a broadcasting environment that provides content through an IPTV receiver more efficiently and user-friendly, using a mobile terminal in an environment interacting with a home network.

To achieve these objects and other advantages in accordance with the purpose of the invention, as embodied and broadly described herein, a method for providing content at an Internet Protocol Television (IPTV) receiver, the method includes connecting to a mobile terminal through a home network, receiving a content Identifier (ID) from the mobile terminal through the home network, and receiving content using the content ID, wherein the content ID includes address information about a content provider from which the content can be received. The connection to a mobile terminal through a home network further comprises performing a discovery operation with the mobile terminal, transmitting device information about the IPTV receiver to the mobile terminal; and performing an event subscribe operation with the mobile terminal.

The content ID includes at least one piece of address information of a Content Reference Identifier (CRID), Uniform Resource Locator (URL), or video ID of the content. The reception of content using the content ID further includes accessing a location of the address information included in the content ID, requesting transmission of the content corresponding to the content ID, and receiving the content.

The method further includes generating and displaying a user interface through which a command to receive the content is input, by receiving the content ID. The home network is connected by a Universal Plug and Play (UPnP) protocol.

In an aspect of the present invention, a method for providing content at an Internet Protocol Television (IPTV) receiver includes a network interface for transmitting and receiving IP packets, a Universal Plug and Play (UPnP) manager for connecting to a home network via the network interface, and a service delivery manager for controlling transmission and reception of data, wherein the UPnP manager connects to a mobile terminal through the home network and receives a content Identifier (ID) from the mobile terminal through the home network by controlling the network interface, and the service delivery manager receives content using the content ID by controlling the network interface, and wherein the content ID includes address information about a content provider from which the content can be received.

The UPnP manager performs a discovery operation with the mobile terminal, transmits device information about the IPTV receiver to the mobile phone, and performs an event subscribe operation with the mobile terminal, by controlling the network interface.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a User Interface (UI) for content search according to an embodiment of the present invention;

FIG. 2 illustrates a UI for content search according to another embodiment of the present invention;

FIG. 3 illustrates a home network interaction method according to an embodiment of the present invention;

FIG. 4 is a conceptual view of a method for providing content using an Internet Protocol Television (IPTV) receiver and a mobile terminal that interact with each other through a home network;

FIG. 5 is a conceptual view of a method for analyzing user information to transmit a content advertisement at a broadcasting service provider according to an embodiment of the present invention;

FIG. 6 is a flowchart illustrating a method for receiving a content advertisement at the mobile phone according to an embodiment of the present invention;

FIG. 7 is a diagram illustrating a signal flow for a method for providing content at the IPTV receiver according to an embodiment of the present invention;

FIG. 8 is a diagram illustrating a signal flow for a method for connecting the mobile phone to the IPTV receiver through the home network according to an embodiment of the present invention;

FIG. 9 is a diagram illustrating a signal flow for a method for providing content at the IPTV receiver using the mobile phone according to an embodiment of the present invention;

FIG. 10 is a diagram illustrating a signal flow for a method for controlling the IPTV receiver using the mobile phone according to an embodiment of the present invention;

FIG. 11 is a diagram illustrating a signal flow for a method for providing content at the IPTV receiver according to another embodiment of the present invention;

FIG. 12 is a diagram illustrating a signal flow for a method for providing content at the IPTV receiver according to a further embodiment of the present invention;

FIG. 13 is a diagram illustrating a signal flow for a billing method added to a content providing method according to an embodiment of the present invention;

FIG. 14 is a diagram illustrating a signal flow for a method for providing content at the IPTV receiver without using home network technology according to another embodiment of the present invention;

FIG. 15 is a flowchart illustrating a method for providing content at the IPTV receiver without using the home network technology according to another embodiment of the present invention;

FIG. 16 is a diagram illustrating a signal flow for a method for providing content at the IPTV receiver without using the home network technology according to another embodiment of the present invention;

FIG. 17 is a diagram illustrating a signal flow for a method for providing content at the IPTV receiver using a PC according to another embodiment of the present invention;

FIG. 18 is a block diagram of the IPTV receiver according to an embodiment of the present invention;

FIG. 19 is a block diagram of the mobile terminal according to an embodiment of the present invention;

FIG. 20 is a flowchart illustrating a content providing method of the IPTV receiver according to an embodiment of the present invention; and

FIG. 21 illustrates UIs of the IPTV receiver according to an embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

The attached drawings and embodiments of the present invention will be described in detail with reference to the attached drawings, which should not be construed as limiting the present invention.

In addition, although the terms used in the present invention are selected from generally known and used terms, the terms may be changed according to the intention of an operator, customs, or the advent of new technology. Some of the terms mentioned in the description of the present invention have been selected by the applicant at his or her discretion, the detailed meanings of which are described in relevant parts of the description herein. Therefore, the present invention must be understood, not simply by the actual terms used but by the meanings of each term lying within.

While an Internet Protocol Television (IPTV) receiver is described hereinbelow in the context of digital TV or IPTV, the term IPTV receiver may refer to a set-top box configured separately from a display device (TV) or a device in which a set-top box and a display device are incorporated. A mobile terminal will be described mainly as a mobile phone, by way of example. However, a mobile terminal covers a broad range of communication devices that can be carried with a user, such as a mobile phone, a Personal Digital Assistant (PDA), an MP3 player, a touch pad, etc.

In a digital broadcasting environment that enables interactive communication, a broadcasting service provider can provide services such as Content on Demand (CoD) and Video on Demand (VOD). A digital broadcasting receiver should display such various types of content to a user. Thus the user can search for content on a TV screen and use the detected content.

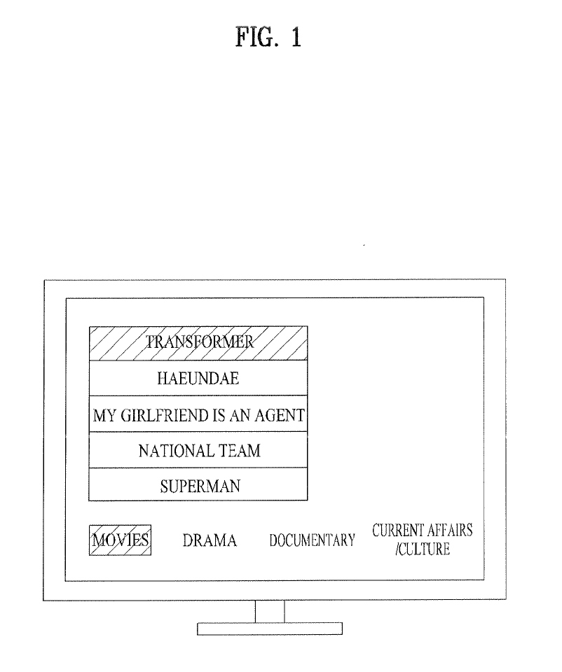

FIG. 1 illustrates a User Interface (UI) for content search according to an embodiment of the present invention.

Referring to FIG. 1, an IPTV receiver may provide a UI on which content is classified by category and thus a user may search for intended content on the UI by means of a remote controller. The UI of FIG. 1 provides a menu system in a browse manner, in which content is classified hierarchically, for example, into large, intermediate, and small categories. In the embodiment of the present invention illustrated in FIG. 1, content is classified first into large categories such as movies, drama, documentary, etc. and then a content list is arranged under each large category, for navigation, that is, in a two-stage classification structure.

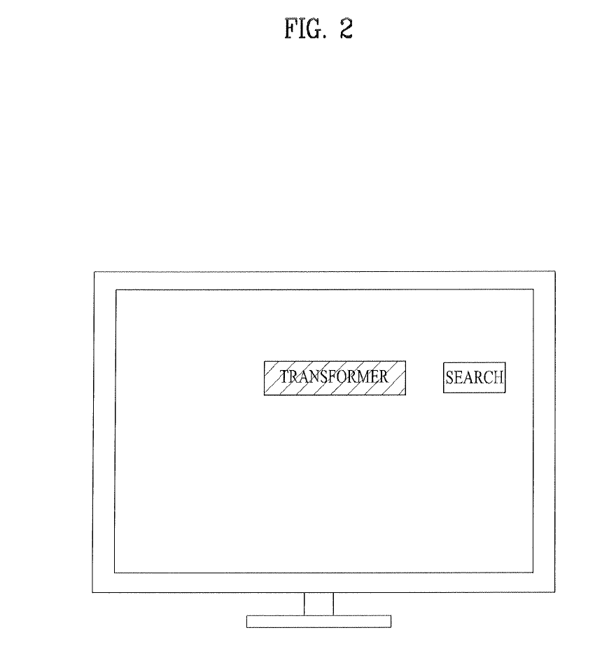

FIG. 2 illustrates a UI for content search according to another embodiment of the present invention.

Referring to FIG. 2, the IPTV receiver displays a UI on which content may be searched by a keyword. When the user enters a keyword, search results are listed and the user detects intended content in the search results. In the presence of a plurality of search results, the search results may be displayed hierarchically (e.g. by category).

A drawback of the content search methods illustrated in FIGS. 1 and 2 is that a user has difficulty in searching for intended content and using the content due to menu complexity. In the keyword input-based search method, a general remote controller for an IPTV receiver is not suitable for typing and the user does not easily detect content unless he or she enters a correct keyword. Moreover, the user may need to enter personal information such as a card number or a password to purchase content after selecting the content, which adds to user inconvenience. Use inconvenience of content is a primary issue to tackle with in order to sell content on the part of a broadcasting service provider. Accordingly, the present invention provides a content providing method for enabling a user to readily use content by home network interaction technology.

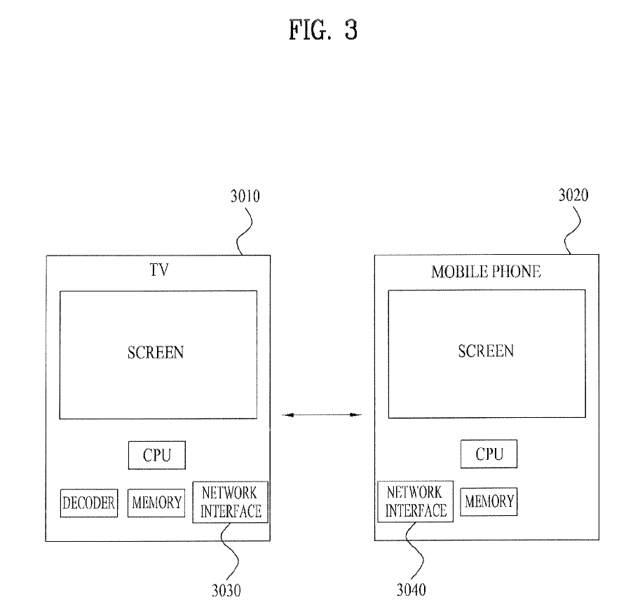

FIG. 3 illustrates a home network interaction method according to an embodiment of the present invention.

In the embodiment of the present invention illustrated in FIG. 3, an IPTV receiver 3010 interacts with a mobile phone 3020 through a home network. The IPTV receiver 3010 and the mobile phone 3020 are equipped with network interfaces 3030 and 3040, respectively and are connected to each other through the network interfaces 3030 and 3040 over the network. In an embodiment of the present invention, a wireless technology such as 802.11a/b/g, Bluetooth, etc. or a wired technology such as 802.3 may be used as a network technology.

The IPTV receiver 3010 may receive metadata through the network interface 3030, for selecting a VOD program and a VOD title. The mobile phone 3020 may interpret and store a VOD advertisement of a broadcasting service provider and may include a remote controller function for controlling the IPTV receiver 3010. Power, channels, volume, etc. of a TV can be controlled with the remote controller function in a conventional single InfraRed (IR) scheme or an interactive network interfacing scheme. Home middleware that connects the IPTV receiver 3010 to the mobile phone 3020 may run in the two devices.

The present invention will be described in the context of a Universal Plug and Play (UPnP) technology being used for a home network and its middleware, by way of example. UPnP is a technology that enables devices such as a PC, a peripheral device, an intelligent home appliance, wireless equipment, etc. to automatically recognize each other by a Web protocol such as the Internet, when they are connected to a network. In UPnP, when a user adds a device to a network, the device completes self-configuration, receives a Transmission Control Protocol/Internet Protocol (TCP/IP) address, and uses an Internet Hyper Text Transmission Protocol (HTTP)-based protocol to announce its existence. A UPnP-based home network interaction method between the IPTV receiver and the mobile terminal will be described below in detail.

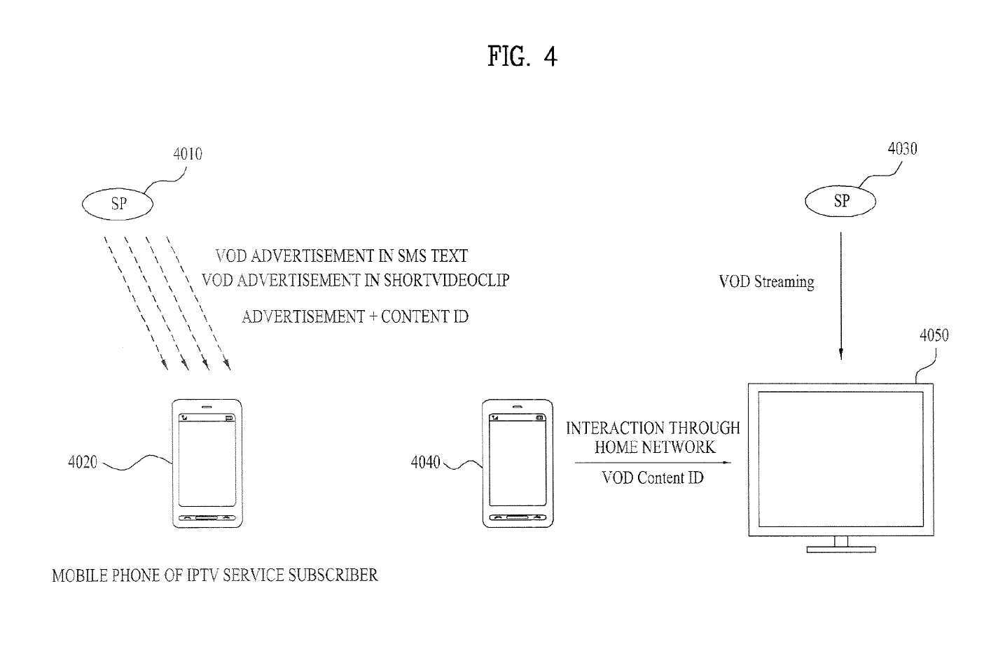

FIG. 4 is a conceptual view of a method for providing content using an IPTV receiver and a mobile terminal that interact with each other through a home network.

In a communication/broadcasting environment, a communication service provider and a broadcasting service provider can provide a communication network and a broadcasting network and provide content through the networks, respectively. Notably, the broadcasting service provider may provide a communication service (e.g. a mobile phone service or an Internet service) and a broadcasting service (e.g. an IPTV service) in a package. In this case, the broadcasting service provider may identify subscribers that use the IPTV service from among mobile phone subscribers. As noted from the left side of FIG. 4, a Service Provider (SP) 4010 may transmit an advertisement related to the IPTV service to a mobile phone 4020 of an IPTV service subscriber. The advertisement related to the IPTV service transmitted to the mobile phone 4020 may include an advertisement (an image or a video) of content and a Content ID in an embodiment of the present invention. The advertisement of the content may take various forms such as a multimedia mail including a Short Message Service (SMS) text message or a video. Hereinbelow, a Content ID may be referred to as a VOD Content ID, a VOD ID, etc.

After a user stores an advertisement of specific content in the mobile phone, he or she may readily use the content using the stored content advertisement or a Content ID included in the content advertisement in a home network environment as illustrated in the right side of FIG. 4. That is, when the user gets home and thus the mobile phone 4040 is connected to the home network and thus to an IPTV receiver 4050 through the home network, the user may transmit the Content ID stored in the mobile phone 4040 to the IPTV receiver 4050 and the IPTV receiver 4050 may receive the content from the broadcasting service provider 4030 using the Content ID and may provide the received content to the user.

In the case where a broadcasting service provider transmits an advertisement, the broadcasting service provider may customize the advertisement to the user by analyzing the IPTV service use pattern of the user, which will be described below.

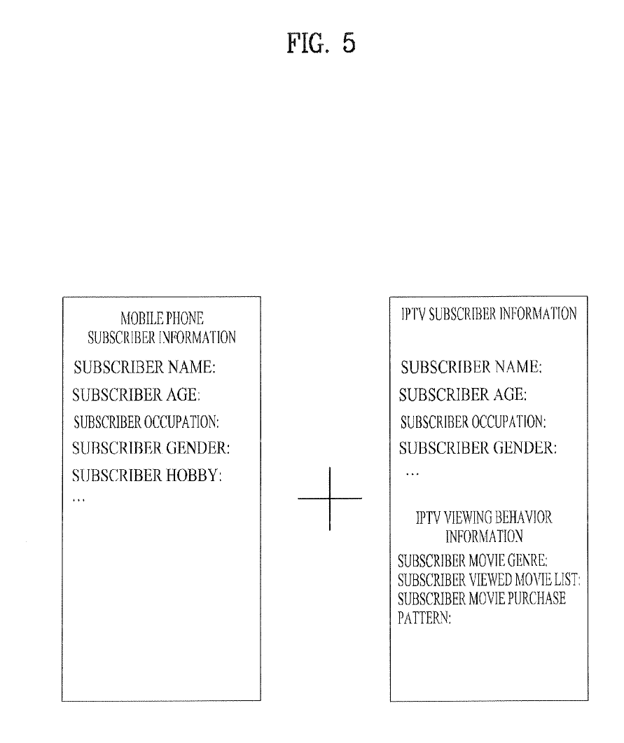

FIG. 5 is a conceptual view of a method for analyzing user information to transmit a content advertisement at a broadcasting service provider according to an embodiment of the present invention.

In the case where a broadcasting service provider provides both an IPTV service and a mobile phone service, the broadcasting service provider needs to analyze information about a user in order to transmit a content advertisement to a mobile phone of the user. Thus the broadcasting service provider may transmit an advertisement customized to the user based on the user information analysis. That is, the broadcasting service provider may transmit an advertisement targeting at a specific subscriber according to the IPTV viewing pattern of the subscriber by analyzing information about the subscriber, as expressed as the following equation.

Target content advertisement elements F(x)=(mobile phone subscriber information, IPTV viewing pattern information, IPTV subscriber information, . . . )

As illustrated in FIG. 5, the broadcasting service provider may analyze information about mobile phone subscribers, analyze information about IPTV subscribers, and determine the subscribers that are at once mobile phone subscriber and IPTV subscribers. The broadcasting service provider may analyze the viewing patterns of the IPTV subscribers such as the genres of movies that they have viewed, lists of viewed movies, movie purchase patterns, etc., derive target content advertisement elements, and transmit content advertisements matching to the elements.

The broadcasting service provider may transmit an advertisement of promoted blockbuster content to all subscribers without analyzing the subscribers. This content may be sufficiently advertised without analysis of individual users. As described above, long-tail content may also have maximized advertisement effects through analysis of user characteristics.

Now a detailed description will be given of a method for transmitting a content advertisement to a mobile terminal and providing content at an IPTV receiver.

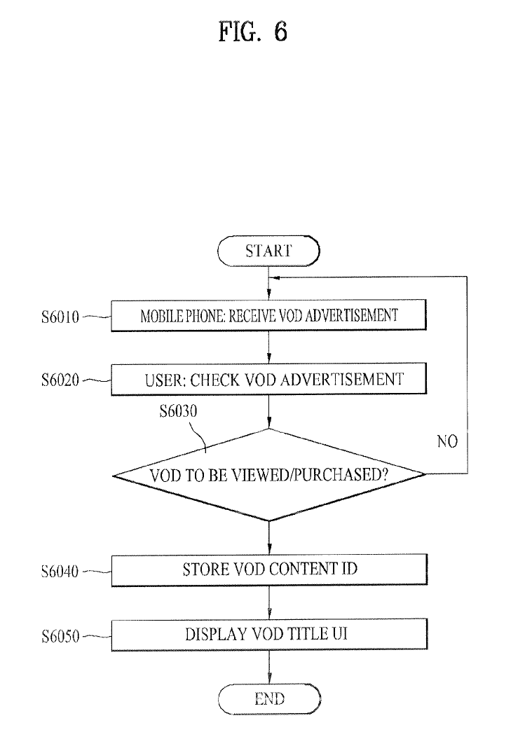

FIG. 6 is a flowchart illustrating a method for receiving a content advertisement at a mobile phone according to an embodiment of the present invention.

This flowchart will be described from the perspective of the mobile phone.

The mobile phone receives a VOD advertisement from a broadcasting service provider (S6010). The content advertisement may be text or Audio/Video (A/V) content of a preview. While VOD is taken as an example of content in the embodiment of the present invention, the content may be any content of various services such as an audio, a video, a product purchase, etc. that can be consumed by the IPTV service. The mobile phone may notify the user of receipt of the content advertisement by vibrations/bell sound and display a UI asking whether the user will use the content advertisement. The received content advertisement may be stored in a memory of the mobile phone so that the user may reproduce and read/view the advertisement at the moment of receiving the advertisement or at a later desired time.

The user may check the content advertisement (S6020) and may determine whether to purchase/consume content advertised by the content advertisement (S6030). When the user determines to purchase/consume the content, the mobile phone may store a Content ID received along with the content advertisement (S6040) and may display a UI for use in future IPTV control by the user, such as the title of the content (S6050). The UI of the content is an embodiment of the present invention. The UI may be configured so as to allow the user to select/operate the UI by creating a link on a background screen of the mobile phone.

A Content ID may be transmitted/received and stored in various forms, to identify content. The Content ID may be a Content Reference Identifier (CRID), a Uniform Resource Location (URL), or a video ID of video data on the Web, for the content. According to embodiments of the present invention, the followings may be Content IDs.

(1) TV Anytime Crid:

crid://bbc.co.uk/olympics/2008/finale/shotput/women

crid://[service provider]/[content link]

(2) DLNA Content URL:

http://10.178.200.80:62354/MediaServerContent_{—}0/000 0000000000006

http://[url:port]/[content link]

(3) Youtube Video ID:

src=http//www.youtube.com/v/7VpLniRbP18

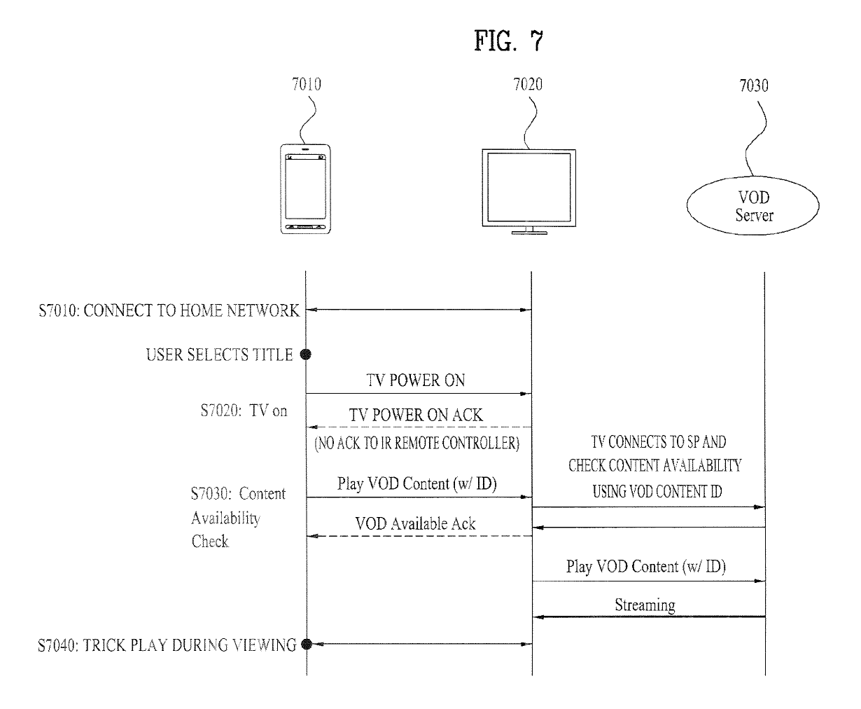

FIG. 7 is a diagram illustrating a signal flow for a method for providing content at an IPTV receiver according to an embodiment of the present invention.

FIG. 7 illustrates a method for providing content using a Content ID at an IPTV receiver in a home network environment, after a mobile phone stores a Content ID as illustrated in FIG. 6. That is, a mobile phone 7010 stores a Content ID by performing the procedure of FIG. 6 in FIG. 7.

The mobile phone 7010 is connected to the home network and thus to an IPTV receiver 7020 through the home network (S7010). When a user selects a VOD title or content execution, the mobile phone 7010 turns on a digital broadcasting receiver through the home network (S7020). Upon receipt of a content execution command from the mobile phone 7010, the IPTV receiver 7020 accesses a VOD server 7030 of a service provider or a broadcasting service provider, checks whether the content is available, and transmits a check result to the mobile phone 7010 (S7030). If the content is available, the IPTV receiver 7020 receives the content (by streaming) and provides the received content to the user. While the user is viewing the content, the IPTV receiver 7020 may receive a manipulation command such as a trick play command from the mobile phone 7010 and thus may operate according to the manipulation command (S7030).

Now, each step of FIG. 7 will be described in more detail.

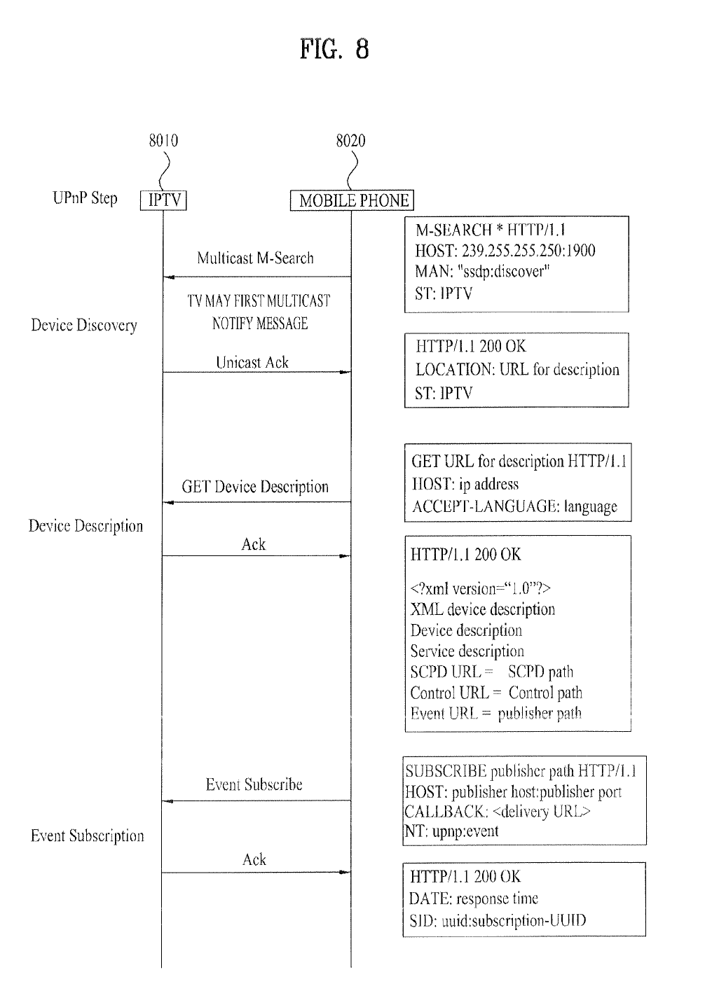

FIG. 8 is a diagram illustrating a signal flow for a method for connecting the mobile phone to the IPTV receiver through the home network according to an embodiment of the present invention.

FIG. 8 illustrates step 57010 of FIG. 7 in great detail, especially home network connection in UPnP.

In an UPnP home network, devices connected to the home network are classified into a control point and a controlled point and the network is defined and established between the devices according to the classification. The present invention is described on the assumption that the mobile phone is a control point and the IPTV receiver is a controlled point.

When entering the coverage area of a home network, a mobile phone 8020 multicasts an M-search command in order to search for an IPTV receiver 8010. Upon receipt of the M-search command, the IPTV receiver 8010 unicasts an Acknowledgment (Ack) along with information about its URL in the home network to the mobile phone 8020. The URL information transmitted by the IPTV receiver 8010 is a network address of the IPTV receiver 8010 in the home network that uses the UPnP protocol. The transmission entities and transmission order of the M-search command and Ack may be changed and thus the transmission of the M-search command and Ack may be initiated by the IPTV receiver 8010.

The mobile phone 8020 transmits a device information request command, Get Device Description to the received address of the IPTV receiver 8010. The IPTV receiver 8010 transmits an Ack for the Get Device Description command. The Ack may include a device description of the IPTV receiver 8010 or property information about the IPTV receiver 8010 in response to the Get Device Description. In an embodiment of the present invention, the device description may include a manufacturer name, a model name, a model number, a serial number, URL information for control and events, etc.

Upon receipt of the device description, the mobile phone 8020 transmits an Event Subscribe command. After a control point searches for a controlled point and acquires information about the controlled point and an associated service, the control point may control the controlled point by an event in the UPnP protocol. To allow transmission and reception of such an event, the control point transmits information about events to be performed to the controlled point and thus prepares for controlling the control point through an event. Herein, an event is a notification of one or more changes in stable variables represented by a service (or a part of a control operation). The mobile phone 8020 being a control point transmits a Simple Object Access Protocol (SOAP) message in a control path described by a service description in order to control a service provided by the IPTV receiver 8010. Upon receipt of an Ack for the Even Subscribe command from the IPTV receiver 8010, the mobile phone 8020 may be connected to the home network and thus may control the IPTV receiver 8010 by the UPnP protocol.

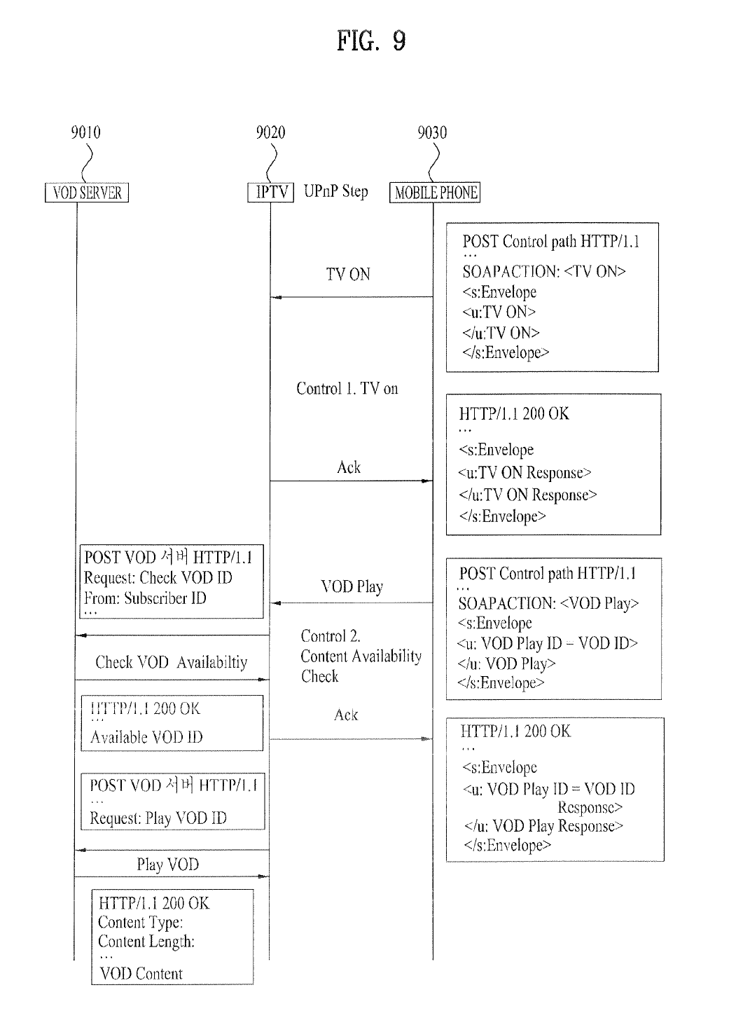

FIG. 9 is a diagram illustrating a signal flow for a method for providing content at the IPTV receiver using the mobile phone according to an embodiment of the present invention.

FIG. 9 illustrates steps S7020 and S7030 of FIG. 7 in great detail. That is, a method for controlling the IPTV receiver at the mobile phone connected to the home network by the UPnP protocol in the procedure of FIG. 8 is described in more detail. The following description is given with the appreciation that a mobile phone 9030 communicates with an IPTV receiver 9020 through a home network by the UPnP protocol.

When the mobile phone 9030 transmits a TV ON command, the IPTV receiver 9020 is powered on and transmits an Ack in response to the TV ON command before or after the power-on. The IPTV receiver 9020 may be powered on when the IPTV receiver 9020 is placed in idle mode, that is, the IPTV receiver 9020 blocks power supply to an external display, etc. and awaits receipt of an external input. If the IPTV receiver 9020 is already in on-state or powered on by a remote controller other than the mobile phone 9030, the step of transmitting a TV ON command to the IPTV receiver 9020 and receiving an Ack from the IPTV receiver 9020 may not be performed in FIG. 9.

If the mobile phone 9030 confirms the power-on of the IPTV receiver 9020, the mobile phone 9030 transmits a VOD Play command. As illustrated in FIG. 9, the VOD Play command includes a VOD ID of the content. The IPTV receiver 9020 is connected to a VOD server 9010 using the received VOD ID and transmits a Check VOD Availability message asking whether the content is available (can be received and reproduced) to the VOD server 9010. Then the IPTV receiver 9020 notifies the mobile phone 9030 whether the content is available. If the content is available, the IPTV receiver 9020 transmits a Play VOD request to the VOD server 9010, downloads the content from the VOD server 9010, and plays the content.

The IPTV receiver 9020 may transmit the notification of whether the content is available after or during receiving the content from the VOD server 9010. In this case, the mobile phone 9030 may be aware that the content is surely playable. If the content can be directly played, the IPTV receiver 920 may play the content without transmitting the notification.

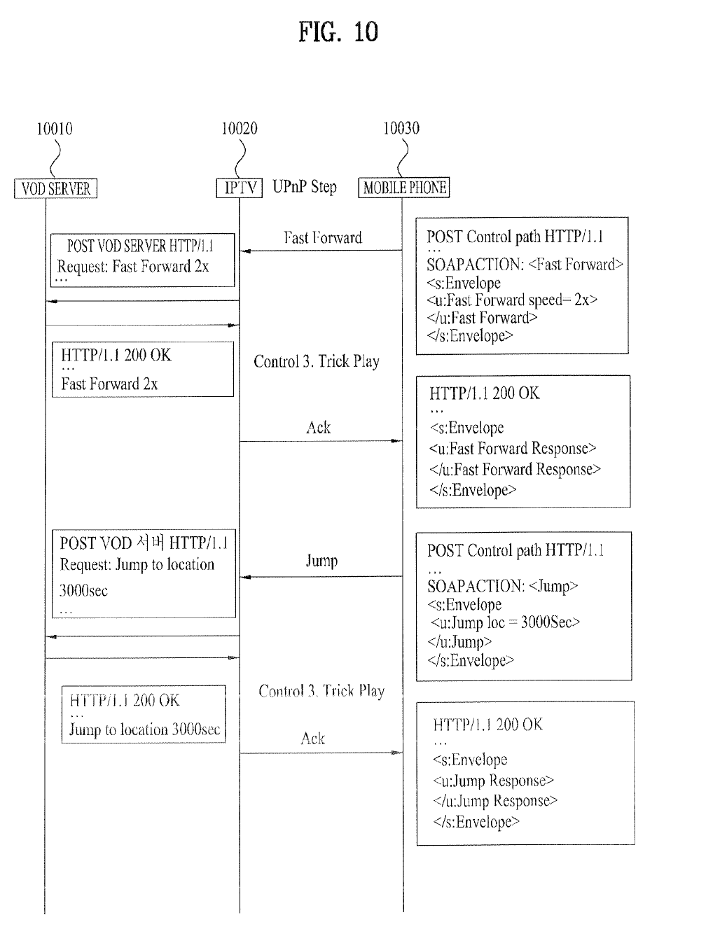

FIG. 10 is a diagram illustrating a signal flow for a method for controlling the IPTV receiver using the mobile phone according to an embodiment of the present invention.

FIG. 10 illustrates step 57040 of FIG. 7 in great detail, especially a method for controlling the IPTV receiver at the mobile phone connected to the home network by the UPnP protocol.

In the case where a mobile phone 1030 interacts with an IPTV receiver 10020 by the UPnP protocol, a user may control the operation of the IPTV receiver 10020 using the mobile phone 1030. Functions of the IPTV receiver 10020 that can be controlled by the mobile phone 10030 may include various trick play functions of a remote controller such as rewind, fast forward, jump, multiple setting, pause, etc. Herein, the fast forward and jump functions will be described in the embodiment of the present invention.

Upon receipt of a Fast Forward command from the mobile phone 10030, the IPTV receiver 10020 transmits the Fast Forward command to a VOD server 10010, receives content corresponding to a preset multiple speed (a 2-multiple speed in FIG. 10), and displays the content. If the content is already downloaded, the IPTV receiver 10020 may adjust the play speed of the stored content without accessing the VOD server 10010. The embodiment of FIG. 10 is applicable to the case where content is received by streaming.

Upon receipt of a Jump command from the mobile phone 10030, the IPTV receiver 10020 transmits a Jump command requesting jump to a preset play location to the VOD server 10010, receives the content starting from the preset play location, and displays the received content. In FIG. 10, the interval between play locations, corresponding to the Jump command is 3000 seconds. If the content is already downloaded, the IPTV receiver 10020 may jump to the play location of the stored content and may play the content starting from the play location without accessing the VOD server 10010. The embodiment of FIG. 10 is applicable to the case where content is received by streaming.

An Ack in response to each trick play command may be transmitted for UI updating before an Ack is received from the VOD server 10010. If a remote controller specific to the IPTV receiver 10020 is used instead of the mobile phone 10030, the embodiment of FIG. 10 may not be implemented.

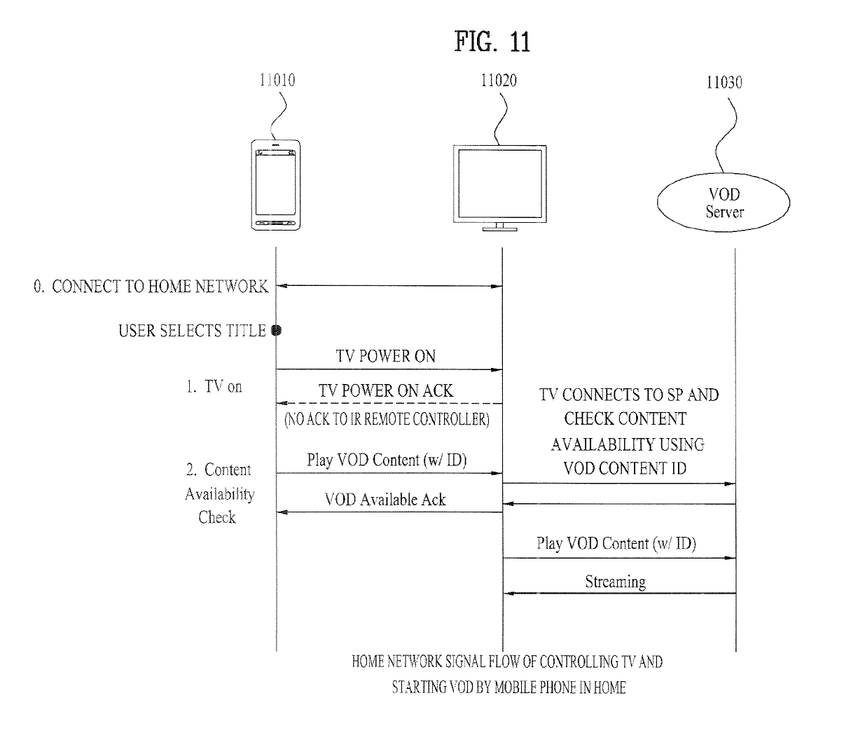

FIG. 11 is a diagram illustrating a signal flow for a method for providing content at the IPTV receiver according to another embodiment of the present invention.

In the embodiment of the present invention illustrated in FIG. 11, a mobile phone 11010 controls only selection and play of a VOD title (VOD content) and an operation of an IPTV receiver 11020 such as trick play is controlled by a remote controller during content play and content viewing, unlike FIGS. 7 to 10. Step S7040 of FIG. 7 is omitted in FIG. 11 and other same steps will not be described herein.

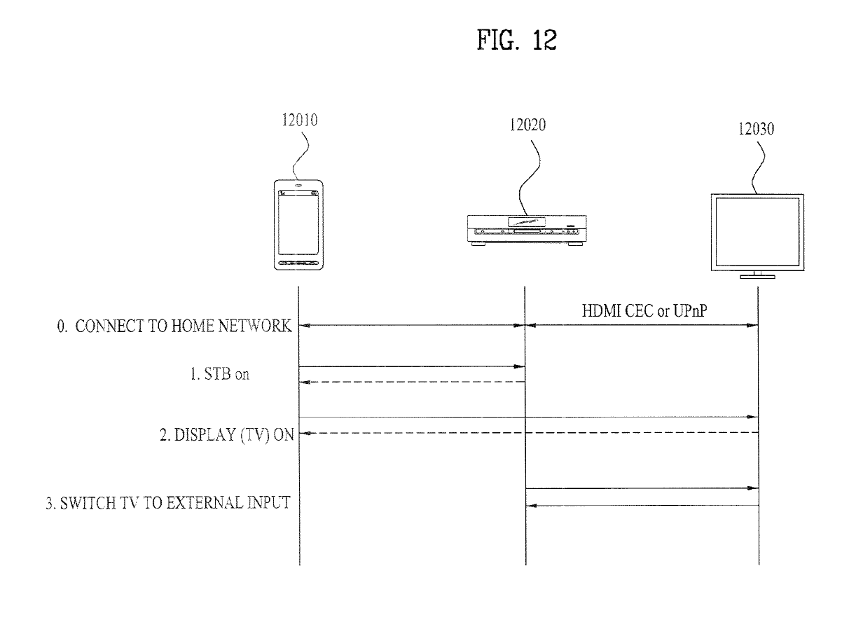

FIG. 12 is a diagram illustrating a signal flow for a method for providing content at the IPTV receiver according to a further embodiment of the present invention.

In case of an IPTV receiver having a built-in set-top box, which is capable of accessing the Internet, once the IPTV receiver is home-networked to a mobile phone 12020, the IPTV receiver may provide VOD content immediately, upon power on. On the other hand, in the case where an IPTV receiver 12020 and a display device 12030 are separately provided, like a set-top box, input and output of the IPTV receiver 12020 and the display device 12030 as well as power-on should be adjusted by a home network protocol, which will be described below with reference to FIG. 12.

Referring to FIG. 12, the IPTV receiver 12020 and the display device 12030 are connected to a home network via a High Definition Multimedia Interface (HDMI) or by UPnP. In this case, an external input to the display device 12030 should be adjusted according to an output of the IPTV receiver 12020. If they are connected via the HDMI, the output of the IPTV receiver 12020 may be converted to the external input of the display device 12030 by a Consumer Electronics Control (CEC) protocol. If the IPTV receiver 12020 and the display device 12030 can be connected to the home network, the mobile phone 12010 is connected to the display device 12030 through the network by the UPnP protocol and thus the IPTV receiver 12020 and the display device 12030 may be controlled by the mobile phone 12010 as described before with reference to FIGS. 7 and 8.

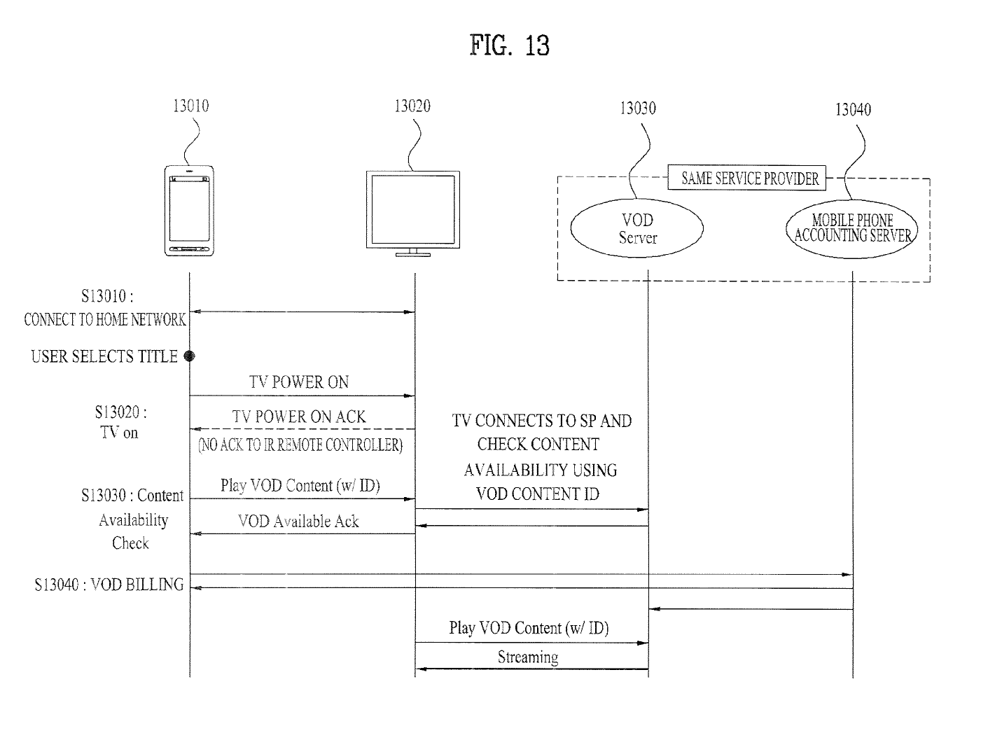

FIG. 13 is a diagram illustrating a signal flow for a billing method added to a content providing method according to an embodiment of the present invention.

Referring to FIG. 13, steps S13010, S13020, and S13030 are performed in the same manner as described before with reference to FIG. 7 and a billing step S13040 is added before content consumption in the procedure of FIG. 13. After content availability is checked in steps S13010, S13020 and S13030, a fee may need to be charged for the use of content. In this case, the broadcasting service provider may receive payment for viewing content by the mobile phone service that outperforms the IPTV service in terms of security. The billing step S13040 may be performed as illustrated in FIG. 13.

When the mobile phone 13010 transmits accounting information to a mobile phone accounting server 13040, the mobile phone accounting server 13040 processes content payment using the accounting information. Upon completion of processing the content payment, the mobile phone accounting server 13040 may notify the mobile phone 13010 of successful payment processing and may notify a VOD server 13030 of the payment completion. Since the VOD server 13030 is aware that the payment for the requested content has been completed, it transmits the content, upon receipt of a content play request from the IPTV receiver 13020.

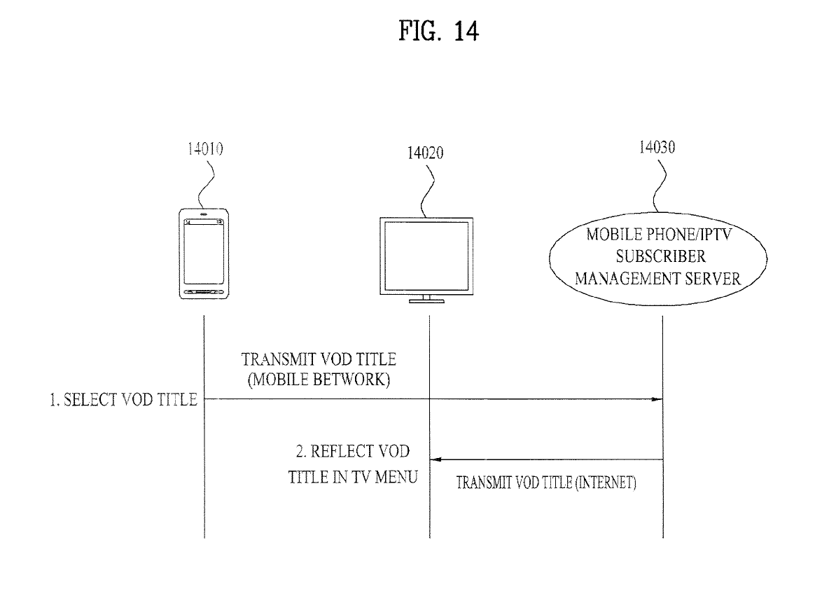

FIG. 14 is a diagram illustrating a signal flow for a method for providing content at the IPTV without using the home network technology according to another embodiment of the present invention.

In the foregoing method for providing content at an IPTV receiver, a mobile phone that has stored a Content ID is connected to an IPTV receiver by the home network technology. In contrast, FIG. 14 depicts a method for providing content without using home network technology, unlike the above-described embodiments of the present invention.

When a user subscribes to a mobile service and an IPTV service from one service provider, content selected by a mobile phone may be transmitted to an IPTV receiver. That is, when a mobile phone 14010 receives an advertisement of content and determines to consume the content in the method illustrated in FIGS. 4, 5 and 6, the mobile phone 14010 may transmit information about the selected content to a mobile phone/IPTV service subscriber management server 14030 as illustrated in FIG. 14. The mobile phone/IPTV service subscriber management server 14030 is a server of a service provider for managing information about mobile phone subscribers and IPTV service subscribers. While a mobile phone service server and an IPTV service server may be separately configured and thus may communicate with each other, they are shown as incorporated into one server in FIG. 14, for the convenience' sake.

The mobile phone/IPTV service subscriber management server 14030 transmits content to be consumed by a user or information for executing the content to the IPTV receiver 14020 using content information received from the mobile phone 14030. When the user uses the IPTV receiver 14020 later, the IPTV receiver 14020 may display a UI such as a shortcut icon so that the user may view the content immediately by selecting the UI. In an embodiment of the present invention, the UI may be provided as a screen menu that is immediately accessible on a home screen or as a menu that can be immediately selected on a home screen, such as a favorite VOD menu.

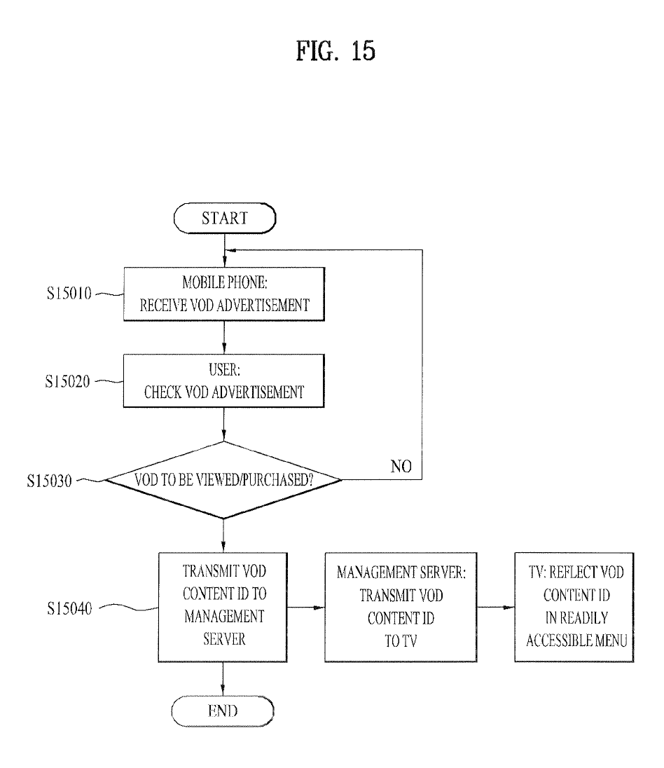

FIG. 15 is a flowchart illustrating a method for providing content at the IPTV receiver without using the home network technology according to another embodiment of the present invention.

FIG. 15 illustrates the method for providing content at the IPTV receiver, described with reference to FIG. 14, without using the home network technology.

The mobile phone receives a VOD advertisement (S15010) and the user views the received VOD advertisement (S15020). Then the user determines whether to view or consume/purchase VOD content by viewing the received VOD advertisement. When the user determines to view the VOD content (S15030), the mobile phone transmits a VOD Content ID to a management server (S15040). In this case, the VOD Content ID identifies the VOD content and the management server may be a management server for a mobile phone/IPTV service.

The management server may transmit the VOD Content ID to the IPTV receiver by the IPTV service and the IPTV receiver may display the received VOD Content ID as a UI such as a readily accessible menu. When this method is completed and the user uses the IPTV receiver, the user can consume the VOD content by immediately executing the VOD content selected by the mobile phone on the menu.

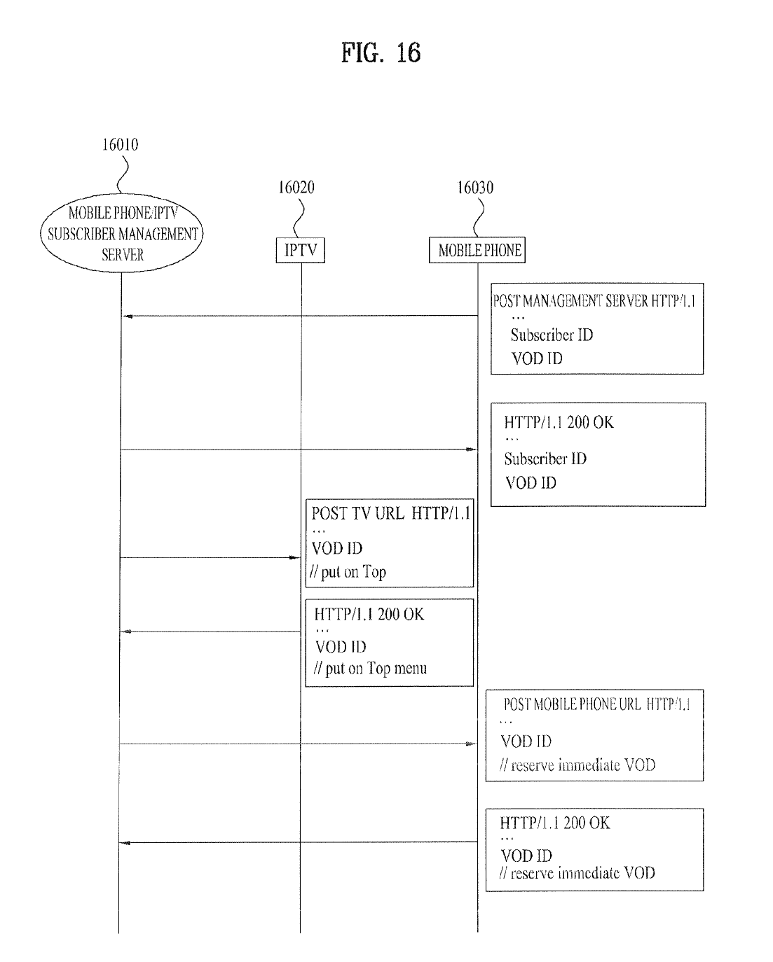

FIG. 16 is a diagram illustrating a signal flow for a method for providing content at the IPTV without using the home network technology according to another embodiment of the present invention.

A description of FIG. 16 is similar to those of FIGS. 14 and 15. Referring to FIG. 16, when a mobile phone 16030 transmits a Subscriber ID and a VOD ID to a mobile phone/IPTV subscriber management server (hereinafter, referred to as a management server) 16010, the management server 16010 transmits an Ack to the mobile phone 16030 and transmits the VOD ID and a command to display the VOD ID on a UI, i.e. a //put on Top or //Put on ToP menu command to the IPTV receiver 16020. The IPTV receiver 16020 transmits an Ack to the management server 16010 and displays the VOD ID on a UI.

Optionally, the management server 16010 may notify the mobile phone 16030 that the content is completely reserved and registered to the IPTV receiver 1620.

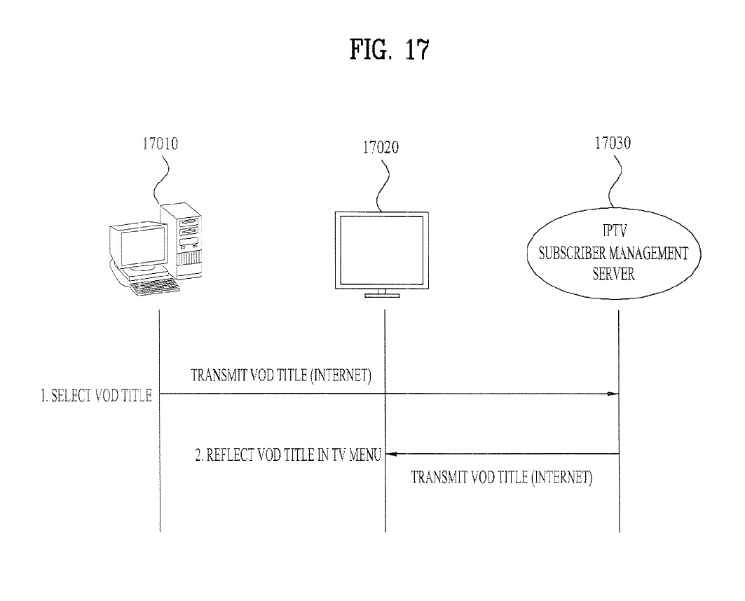

FIG. 17 is a diagram illustrating a signal flow for a method for providing content at the IPTV using a PC according to another embodiment of the present invention.

A user may search for VOD content using a PC 17010. The user may access the Internet using the PC 17010 and search for content using various media of the Internet. The user may also access a management server 17030 or site of an IPTV service provider to which the user has subscribed and search for content in the management server 17030 or site. In this case, the user may request transmission of content to the management server 17030 by the subscribed IPTV service. That is, the user may access the management server 17030 of the IPTV service provider through the PC 17010 and request the management server 17030 to transmit specific content or the ID of the specific content to the IPTV receiver 17020. When the management server 17030 transmits the ID of the content to the IPTV receiver 17020, the IPTV receiver 17020 may reflect the content (a VOD title) on a background screen or a menu so that the user may readily consume the content.

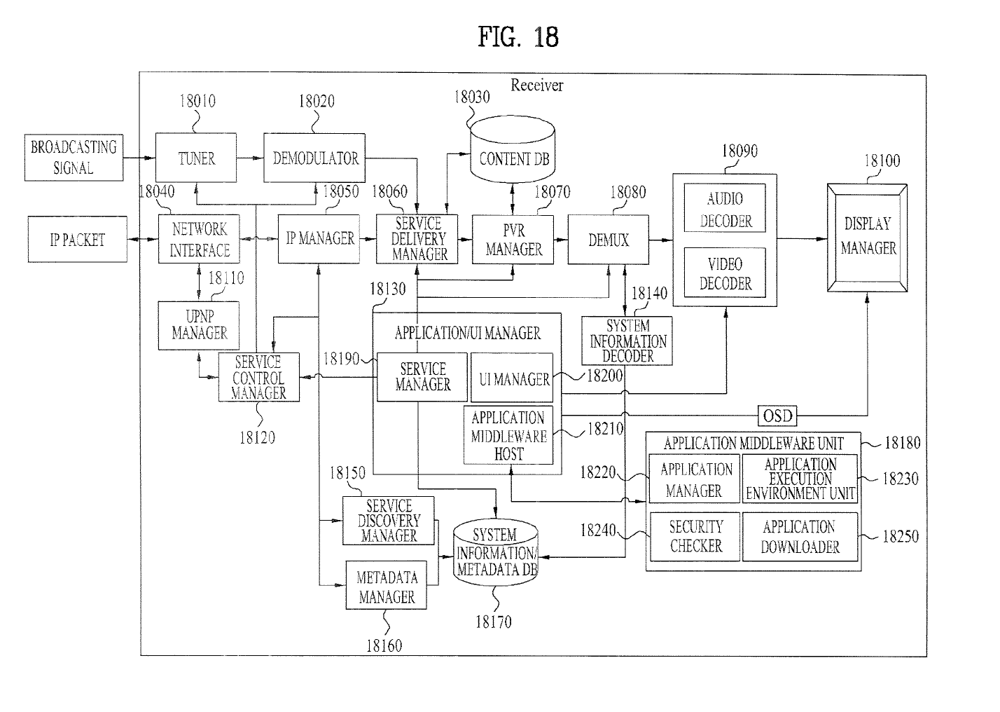

FIG. 18 is a block diagram of the IPTV receiver according to an embodiment of the present invention.

Referring to FIG. 18, the IPTV receiver includes a tuner 18010, a demodulator 18020, a content DataBase (DB) 18030, a network interface 18040, an IP manager 18050, a service delivery manager 18060, a Personal Video Record (PVR) manager 18070, a Demultiplexer (DEMUX) 18080, an A/V decoder 18090, a display manager 18100, a UPnP manager 18110, a service control manager 18120, an application/UI manager 18130, a system information decoder 18140, a service discovery manager 18150, a metadata manager 18160, a system information/metadata DB 18170, and an application middleware unit 18180. The application/UI manager 18130 includes a service manager 18190, a UI manager 18200, and an application middleware host 18210. The application middleware unit 18180 includes an application manager 18220, an application execution environment unit 18230, a security checker 18240, and an application downloader 18250. Each component of the IPTV receiver will be described below.

The tuner 18010 receives a terrestrial or cable broadcasting signal. The demodulator 18020 demodulates the broadcasting signal received at the tuner 18010 in 64/256 Vestigial SideBand (VSB) or 64/256 Quadrature Amplitude Modulation (QAM) according to an embodiment of the present invention. The content DB 18030 is a DB in which received content or live media broadcasting is stored.

The network interface 18040 transmits/receives an IP packet. The IP manager 18050 controls packet delivery between a receiver of the network interface 18040 and the outside. The service delivery manager 18060 controls and performs content download and real-time data streaming. In this case, Real-Time Transport Protocol (RTP)/RTP Control Protocol (RTCP) may be used along with an MPEG-2 Transport Stream (TS) and the MPEG-2 TS may be delivered directly by User Datagram Protocol (UDP) without RTP. For content download, an HTTP or File delivery over Unidirectional Transport (FLUTE) protocol may be used as a delivery protocol.

The PVR manager 18070 stores and plays received content. The content may be stored in the content DB 18030. The DEMUX 18080 demultiplexes a received transmission packet into an audio, a video, and system information. Demultiplexing of System Information (SI) may be controlled by the system information decoder 18140. The A/V decoder 18090 decodes A/V elementary stream packets. The display manager 18100 receives the decoded video/audio data and displays the video data on a screen or outputs the audio data. In addition, the display manager 18100 controls On Screen Display (OSD) graphic data.

The UPnP manager 18110 controls and executes UPnP functions (discovery, control, event notification, etc.) for interaction with other devices in the home network. The service control manager 18120 controls/selects services and manages sessions. In an embodiment of the present invention, the service control manager 18120 may select a broadcasting service or VOD content using Internet Group Management Protocol (IGMP) or Real-Time Streaming Protocol (RTSP). In a hybrid receiver capable of additionally receiving a broadcasting signal such as a legacy public broadcasting signal, the service control manager 18120 may control broadcasting signal reception by controlling the tuner and the demodulator and may also control the functions of the UPnP manager 18110.

The application/UI manager 18130 supports a Graphic User Interface (GUI), receives a user input from a remote controller or panel, and manages the state of the remote controller or panel by controlling the entire TV system. The service manager 18190 may control the service control manager 18120, the service delivery manager 18060, the service discovery manager 18150, and the metadata manager 18160. These managers may be collectively referred to as a controller. The UI manager 18200 controls a UI displayed on a screen. The application middleware host 18170 controls the application middleware unit 18180 and takes charge of adaptation.

The service discovery manager 18150 discovers or searches for IPTV services in an interactive IP network. The metadata manager 18160 manages metadata such as system information and controls the system according to the metadata. The system information/metadata DB 18170 is a DB in which service discovery information and service-related metadata are stored.

The application middleware unit 18180 manages application middleware and provides necessary functions during a whole application execution period (installation, execution, management, and deletion). In addition, the application middleware unit 18180 may interact with the application middleware host 18210 to utilize host functions (resources, UPnP functions, etc.).

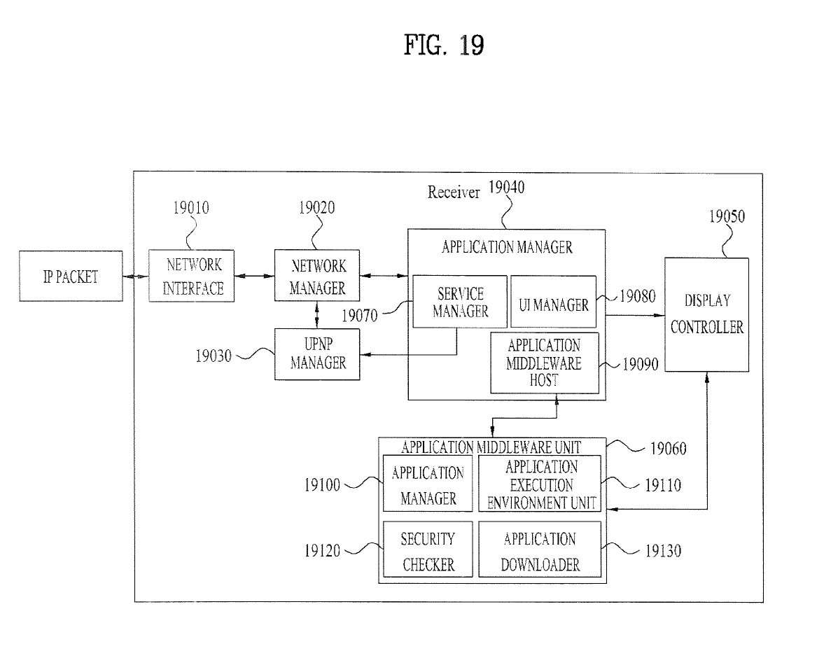

FIG. 19 is a block diagram of the mobile terminal according to an embodiment of the present invention.

Referring to FIG. 19, the mobile terminal includes a network interface 19010, a network manager 19020, an UPnP manager 19030, an application manager 19040, a display controller 19050, and an application middleware unit 19060. The application manager 19040 includes a service manager 19070, a UI manager 19080, and an application middleware host 19090. The application middleware unit 19060 includes an application manager 19100, an application execution environment unit 19110, a security checker 19120, and an application downloader 19130.

The network interface 19010 transmits/receives an IP packet. The network manager 19020 delivers packets between the mobile terminal and the outside through the network interface 19010. In this case, RTP/RTCP may be used along with an MPEG-2 TS and the MPEG-2 TS may be delivered directly by UDP without RTP. For content download, an HTTP or FLUTE protocol may be used as a delivery protocol.

The UPnP manager 19030 controls and executes UPnP functions (discovery, control, event notification, etc.) for interaction with other devices in the home network.

The application/UI manager 19040 supports a GUI, receives a user input from a remote controller or panel, and manages the state of the remote controller or panel by controlling the entire TV system. The service manager 19070 may control other service-related managers (the network manager 19020 and the UPnP manager 19030). These managers may be collectively referred to as a controller. The UI manager 19080 controls a UI displayed on a screen. The application middleware host 19010 controls the application middleware unit 19060 and takes charge of adaptation.

The display manager 19050 receives the decoded video/audio data and displays the video data on a screen or outputs the audio data. In addition, the display manager 19050 controls OSD graphic data.

The application middleware unit 19060 manages application middleware and provides necessary functions during a whole application execution period (installation, execution, management, and deletion). In addition, the application middleware unit 19060 may interact with the application middleware host 19090 to utilize host functions (resources, UPnP functions, etc.).

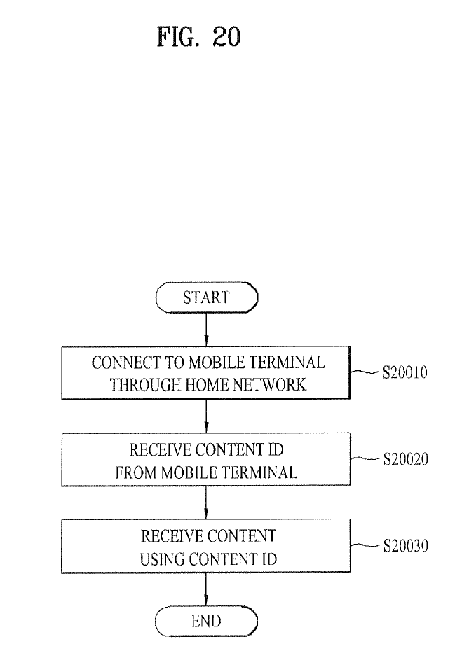

FIG. 20 is a flowchart illustrating a content providing method of the IPTV receiver according to an embodiment of the present invention.

In the flowchart of FIG. 20, the mobile terminal receives a content advertisement and stores a Content ID, as described before with reference to FIGS. 4, 5 and 6. The content ID may include address information that identifies content, in the afore-described format. That is, the Content ID is information about an address from which the content can be provided or received, which may be configured in at least one format of a CRID, a URL, or a video ID. The address information may include information about an access address or server address of a content provider.

The IPTV receiver is connected to the mobile terminal through the network interface and the UPnP manager over the home network (S20010). The IPTV receiver and the mobile terminal may connect to the home network by the UPnP protocol. In this case, the IPTV receiver and the mobile terminal perform a device discovery operation in the network. The IPTV receiver may transmit device information to the mobile terminal and perform an event subscribe operation with the mobile terminal, as described before with reference to FIG. 8.

The IPTV receiver receives the Content ID from the mobile terminal via the network interface (S20020). In addition, the IPTV receiver may receive the Content ID and display a UI that provides a shortcut to content corresponding to the Content ID. The IPTV receiver may generate and display the UI through the display manager. The controller of the IPTV receiver may interpret the Content ID and thus acquire access address information. The controller may correspond to the service delivery manager.

The IPTV receiver receives the content using the Content ID via the network interface and the service delivery manager (S20030). The IPTV receiver accesses an address included in the Content ID via the network interface controlled by the service delivery manager and requests transmission of the content corresponding to the Content ID to the accessed server or content provider. Then the IPTV receiver receives the content.

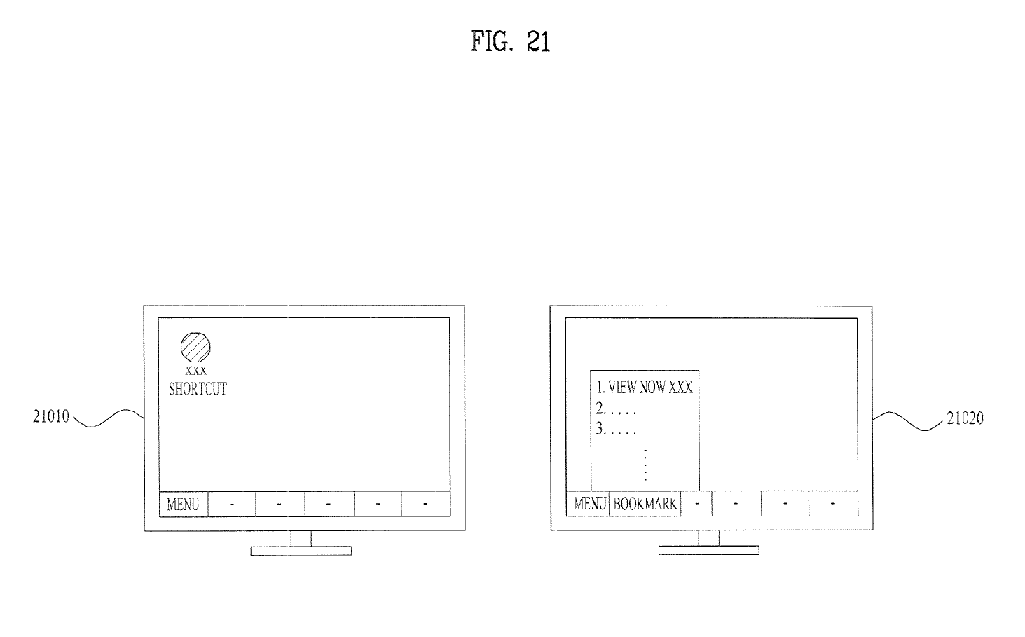

FIG. 21 illustrates UIs of the IPTV receiver according to an embodiment of the present invention.

Screens of the IPTV receiver illustrated in FIG. 21 are an embodiment of UIs that can provide a shortcut to content. That is, when the IPTV receiver receives a Content ID as described with reference to FIG. 20, the IPTV receiver may be connected directly to the network, receive content, provide the received content, and generate and provide a UI through which the content can be received directly and provided to a user.

The IPTV receiver may generate and display a shortcut icon on a background screen like a screen 21010, so that content XXX may be received directly. When the user selects the icon, the IPTV receiver may receive the content XXX directly without browsing a complex menu or searching for content and provide the content XXX to the user.

The IPTV receiver may also add a menu such as bookmark in a menu part such as a screen 21020 and add a menu item for directly receiving the content XXX under the menu. Due to advertisements from service providers, it may be difficult to edit and arrange a background screen in the IPTV receiver. In this case, it may be difficult to add an icon as in the screen 21010. Therefore, a shortcut menu to content may be added as a sub-menu of the menu. Consequently, a plurality of shortcut menus may be added/deleted flexibly without changing the background screen.

The methods according to the present invention may be implemented as program commands that can be executed by various computer means and written to a computer-readable recording medium. The computer-readable recording medium may include a program command, a data file, a data structure, etc. alone or in combination. The program commands written to the medium are designed or configured especially for the present invention, or known to those skilled in computer software. Examples of the computer-readable recording medium include magnetic media such as a hard disk, a floppy disk, and a magnetic tape, optical media such as a CD-ROM and a DVD, magneto-optical media such as a floptical disk, and a hardware device configured especially to store and execute a program command, such as a ROM, a RAM, and a flash memory. Examples of a program command include a premium language code executable by a computer using an interpreter as well as a machine language code made by a compiler. The hardware device may be configured to operate as one or more software modules to implement the present invention or vice versa.

According to the embodiments of the present invention, a user can receive and use content more readily through an IPTV receiver in a home network environment. Therefore, user convenience can be increased.

According to the embodiments of the present invention, since an advertisement of content can be transmitted to a mobile terminal in a manner that reflects a user pattern of an IPTV service, advertisement effects can be maximized.

According to the embodiments of the present invention, a protocol can be simplified between an IPTV receiver and a mobile terminal because the IPTV receiver and the mobile terminal can identify content and transmit information, using a Content Identifier (ID).

According to the embodiments of the present invention, the IPTV receiver interacts with the mobile terminal interact through a home network by a Universal Plug and Play (UPnP) protocol. The resulting simple connectivity to the home network enables various control operations on the IPTV receiver through the mobile terminal.

While the present invention has been particularly shown and described with reference to embodiments thereof, it will be understood by those of ordinary skill in the art that various changes in form and details may be made therein without departing from the spirit and scope of the present invention as defined by the appended claims and their legal equivalents.

What is claimed is:

1. A method for providing content at an Internet Protocol Television (IPTV) receiver, the method comprising:
connecting to a mobile terminal through a home network;
receiving a content Identifier (ID) from the mobile terminal through the home network; and
receiving content using the content ID,
wherein the content ID includes address information about a content provider from which the content can be received.

2. The method according to claim 1, wherein the connection to a mobile terminal through a home network further comprises:
performing a discovery operation with the mobile terminal;
transmitting device information about the IPTV receiver to the mobile terminal; and
performing an event subscribe operation with the mobile terminal.

3. The method according to claim 1, wherein the content ID includes at least one piece of address information of a Content Reference Identifier (CRID), Uniform Resource Locator (URL), or video ID of the content.

4. The method according to claim 1, wherein the reception of content using the content ID further comprises:
accessing a location of the address information included in the content ID;
requesting transmission of the content corresponding to the content ID; and
receiving the content.

5. The method according to claim 1, further comprising generating and displaying a user interface through which a command to receive the content is input, by receiving the content ID.

6. The method according to claim 1, wherein the home network is connected by a Universal Plug and Play (UPnP) protocol.

7. An Internet Protocol Television (IPTV) receiver comprising:
a network interface for transmitting and receiving IP packets;
a Universal Plug and Play (UPnP) manager for connecting to a home network via the network interface; and
a service delivery manager for controlling transmission and reception of data,
wherein the UPnP manager connects to a mobile terminal through the home network and receives a content Identifier (ID) from the mobile terminal through the home network by controlling the network interface, and the service delivery manager receives content using the content ID by controlling the network interface, and
wherein the content ID includes address information about a content provider from which the content can be received.

8. The IPTV receiver according to claim 7, wherein the UPnP manager performs a discovery operation with the mobile terminal, transmits device information about the IPTV receiver to the mobile phone, and performs an event subscribe operation with the mobile terminal, by controlling the network interface.

9. The IPTV receiver according to claim 7, wherein the content ID includes at least one piece of address information of a Content Reference Identifier (CRID), Uniform Resource Locator (URL), or video ID of the content.

10. The IPTV receiver according to claim 7, wherein the service delivery manager accesses a location of the address information included in the content ID, requests transmission of the content corresponding to the content ID, and receives the content, by controlling the network interface.

11. The IPTV receiver according to claim 7, further comprising a display manager for generating and displaying a user interface through a command to receive the content is input by receiving the content ID.

12. The IPTV receiver according to claim 7, wherein the UPnP manager connects to the home network by an UPnP protocol.
